(19) United States
(12) Patent Application Publication
(10) Pub. No.: US 2026/0048484 A1
(43) Pub. Date: Feb. 19, 2026

(54) NEGATIVE-PRESSURE ELEMENT FOR A (NEGATIVE-PRESSURE) WORK SURFACE

(71) Applicant: CELLCENTRIC GMBH & CO. KG, Kirchheim/Teck-Nabern (DE)

(72) Inventor: Thomas MAASSEN, Burnaby, BC (CA)

(21) Appl. No.: 19/124,481

(22) PCT Filed: Oct. 25, 2023
(86) PCT No.: PCT/EP2023/079768

§ 371 Date: Apr. 25, 2025

(30) Foreign Application Priority Data
Oct. 26, 2022 (DE) 102022211377.2

(51) Int. Cl. B25B 11/00

(52) U.S. Cl. CPC B25B 11/005

(57) ABSTRACT

The invention relates to a negative-pressure element for arrangement in and/or on a negative-pressure work surface in order to selectively illuminate said negative-pressure work surface, the negative-pressure element comprising: at least one connection which is designed to connect a negative pressure and/or a negative-pressure device; a diffuser layer, the diffuser layer having a perforation at least in sections; a translucent layer, in particular a light-guiding layer, the translucent layer having a perforation at least in sections and being designed to couple light into the diffuser layer; wherein the perforation of the diffuser layer and of the translucent layer is designed such that, when a negative pressure is applied to the negative-pressure element, air can flow through said perforation towards the negative-pressure device; at least one light source, in particular at least one LED, which is configured to emit light towards the translucent layer; at least one volume which is designed to distribute a negative pressure applied to the at least one connection to the perforation, in particular to at least one part of the perforation; and wherein the negative-pressure element is designed such that it can be arranged on a perforated negative-pressure work surface or such that the negative-pressure element can be integrated into a recess in a work surface or a negative-pressure work surface.

The present invention relates to a negative-pressure element for a (negative-pressure) work surface, a negative-pressure work surface which has at least one negative-pressure element, and to a method for detecting the position of an object on a negative-pressure work surface.

Negative-pressure tables without illumination are known from the prior art. These are usually used to fix objects or workpieces on the surface in their position by means of a vacuum or negative-pressure, usually for further processing.

It may be an object of the invention to further improve negative-pressure work surfaces, in particular to enable and/or improve edge detection of objects which are placed on the negative-pressure work surface.

This object is achieved according to the teaching of the independent claims. Various embodiments and developments of the invention are the subject matter of the dependent claims.

In some embodiments of the invention, a negative-pressure element is provided for a work surface and/or a negative-pressure work surface, in particular for a work surface of a work surface assembly or for a negative-pressure work surface of a negative-pressure work surface assembly, in particular in order to illuminate the work surface and/or the negative-pressure work surface in sections and/or selectively. In some embodiments, the negative-pressure element has at least one connection which is designed for connecting a negative-pressure and/or a negative-pressure device. In some embodiments, the negative-pressure element has a diffuser layer, the diffuser layer having a perforation at least in sections. In some embodiments, the negative-pressure element has a translucent layer. In some embodiments, the translucent layer has a perforation at least in sections. In some embodiments, the translucent layer is designed to couple light into the diffuser layer of the negative-pressure element. In some embodiments, the translucent layer can be a light-conducting layer, in particular a layer which conducts light in the direction of the diffuser layer of the negative-pressure element. In some embodiments, the perforation of the diffuser layer, alternatively the perforation of the diffuser layer and the perforation of the translucent layer, is formed such that, in particular when a negative pressure is applied to the negative pressure element, in particular to the at least one connection of the negative pressure element, air can flow through the respective perforation towards the negative pressure or negative pressure device. In some embodiments, the negative-pressure element has at least one light source, in particular at least one light source, which is configured to emit light in the direction of the translucent layer. In some embodiments, the at least one light source is a light-emitting diode (LED). In some embodiments, the negative-pressure element has at least one volume which is designed to “distribute” the negative-pressure or a negative-pressure applied to the at least one connection to the perforation, in particular to at least one part of the perforation. In some embodiments, the at least one volume is adapted to distribute an applied negative-pressure over at least a part of the perforation of the diffuser layer, alternatively over at least a part of the perforation of the diffuser layer and at least a part of the perforation of the translucent layer. In other words, in some embodiments, the at least one volume is configured in such a way that the perforation of the diffuser layer and/or the perforation of the translucent layer are in fluid connection with the at least one connection via the volume. In some embodiments, the negative-pressure element is configured such that it can be arranged or is arrangeable on a perforated negative-pressure work surface, in particular with a surface of the diffuser layer, which can further have or has, in particular, a perforation that is complementary to a perforation of the negative-pressure work surface. In some embodiments, the negative-pressure element is designed in such a way that it has a perforation on a work surface which is complementary to the negative-pressure, in particular (only) in the region in which the negative-pressure element is to be arranged or can be arranged. In some embodiments, the negative-pressure element is configured or designed such that it can be integrated into a recess of a work surface, in particular a work surface without its own negative-pressure connection. In some embodiments, the negative-pressure element is configured so that it can be integrated into a recess of a negative-pressure work surface. For this purpose, the negative-pressure element can, in a further development, have a frame which has at least one connection, a diffuser layer, a translucent layer, at least one reflection surface or reflection layer, at least one light source and at least one volume, in particular as described above.

The term “diffuser layer”, as used herein, is to be understood in particular as meaning a (light) diffuser which is set up to distribute the light incident (on it) at least substantially uniformly.

The term “connection”, as used herein, is to be understood in particular as meaning a fluid connection independent from a specific shape, which is set up in particular to enable a (technical) negative-pressure or a vacuum (in particular in comparison with an ambient pressure and/or atmospheric pressure under normal conditions) and/or a fluid flow in the direction of the negative-pressure or vacuum, in particular to a negative-pressure or vacuum prevailing around the negative-pressure element or to a negative-pressure device. In some embodiments, the term “connection”, as used herein, may be understood to mean a proprietary interface or a commercially available interface, in particular an interface which, by means of connectors, in particular (complementary) plug-in connectors, produces and/or makes possible a fluid connection, in particular to a negative-pressure device, which can be connected in particular via a fluid connection, such as in particular a hose. In some embodiments, a negative-pressure device can be a negative-pressure pump or vacuum pump.

In some embodiments, this advantageously makes it possible for a negative-pressure element to be an individual, in particular separate, lighting unit with (at least a proportional) negative-pressure capacity for negative-pressure fixing of objects. In some embodiments, the negative-pressure element can advantageously be used flexibly in pick-and-place operations and/or roll-to-roll applications, in particular for high(er) contrast edge detection of objects with corresponding edge detection systems and methods. In some embodiments, these can advantageously (more) reliably detect edges on the basis of the illumination contrast advantageously provided by the negative-pressure element. In some embodiments, the negative-pressure element can advantageously permit a (more) uniform illumination intensity via its diffuser layer or on a surface set up for edge detection, so that, in particular, detection of an edge of an object on the negative-pressure element and/or the set-up surface can be simplified.

In some embodiments, the negative-pressure element is designed in such a way that it illuminates or can illuminate a work surface, in particular a work surface without a negative-pressure connection or access to a negative-pressure device, in sections or only a section of the work surface and/or selectively. In other words, in some embodiments, the negative-pressure element is designed in such a way that it does not illuminate a work surface in its entirety, at least substantially. In some embodiments, the negative-pressure element is arranged in a recess of the work surface, in particular is designed to be arranged in a corresponding recess. In some embodiments, the negative-pressure element is designed to be arranged on a work surface. For this purpose, in some embodiments, the work surface has a perforation which, at least substantially, coincides with one or the perforation of the negative-pressure element, in particular is complementary thereto.

In some embodiments, the negative-pressure element is designed in such a way that it can illuminate or illuminates a negative-pressure work surface in sections or only a section of the negative-pressure work surface and/or selectively. In other words, in some embodiments, the negative-pressure element is designed in such a way that it does not illuminate a work surface in its entirety, at least substantially.

In some embodiments, the at least one light source is arranged in such a way that it irradiates laterally into the translucent layer. In some embodiments, the light source is arranged on one side of the negative-pressure element, which is arranged at least substantially perpendicular to the surface of the diffuser layer and/or at least substantially perpendicular to the surface of the translucent layer.

As a result, in some embodiments, the negative-pressure element can advantageously be designed in a space-saving manner.

In some embodiments, the negative pressure element has at least one reflection surface or reflection layer which is designed to reflect the light emitted by the at least one light source in the direction of the translucent layer and/or the diffuser layer. In some embodiments, the at least one reflection surface or reflection layer is designed to reflect light emerging from the translucent layer, at least substantially, in the direction of the translucent layer (130) and/or the diffuser layer (120).

In some embodiments, the at least one volume is arranged between the at least one reflection surface and the translucent layer, in particular in such a way that a “layer sequence” of the negative-pressure element at the location of the volume is: a reflection surface, the volume, a translucent layer and a diffuser layer.

In some embodiments, the at least one volume adjoins the reflection surface in such a way that the negative pressure element then has a “layer sequence”, in which the volume is arranged on the reflection surface, which in turn is arranged on the translucent layer and this in turn is arranged adjacent to the diffuser layer, in other words the “layer sequence” is from bottom to top: volume, reflection layer, translucent layer, diffuser layer. For this purpose, the reflection layer has a perforation at least in sections, in particular in such a way that a fluid, in particular air, can flow through the (respective) perforation to the negative-pressure or to the negative-pressure device.

In some embodiments, the at least one volume is arranged between the diffuser layer and the translucent layer. Correspondingly, in these embodiments, a “layer sequence” is: reflection surface, translucent layer, volume, diffuser layer.

In some embodiments, the at least one volume is at least partially integrated into at least one of the layers mentioned therein, in particular into at least one of the diffuser layer, translucent layer and reflection surface or reflection layer, in particular in such a way that air can flow or flows through the perforation of the diffuser layer and/or the translucent layer, or of the diffuser layer, the translucent layer and the reflection layer, in the direction of the negative pressure or negative pressure device, in particular the layers have, at least in sections, a perforation for this purpose.

By means of an arrangement of the at least one volume described herein, in some embodiments, a perforation of the diffuser layer can advantageously be connected fluidically to the at least one connection in sections, in particular via the perforation of the translucent layer and/or via the perforation of the reflection surface, if it is an embodiment with a reflection surface perforated at least in sections (as described herein).

In some embodiments, the translucent layer has supporting structures, in particular supporting structures, which are designed to support the at least one volume. According to some embodiments, the support structures can support the at least one volume against a diffuser layer and/or against a reflection surface or reflection layer, in particular depending on the arrangement of the at least one volume. Alternatively or additionally, in some embodiments, the diffuser layer and/or the reflection surface or layer can form supporting structures which support the cavity introduced into the negative-pressure element by the at least one volume. In some embodiments, the support structures are designed in such a way that a fluid flow through the at least one volume is not impeded or reduced, at least substantially.

Advantageously, this makes it possible to reduce, in particular prevent, deflection of at least one layer of the negative-pressure element, in particular under applied negative-pressure or external loading by, for example, a weight. Furthermore, in some embodiments, this advantageously increases and/or improves a stiffness of the negative-pressure element. Furthermore, in some embodiments, the at least one volume can thereby advantageously be integrated into one or more of the layers of the negative-pressure element and thus a structural volume of the negative-pressure element can be (further) reduced.

In some embodiments, the perforation of the diffuser layer is arranged offset from the perforation of the translucent layer. In some embodiments, the perforation (if present) of the reflection surface is arranged offset from the perforation of the translucent layer.

In some embodiments, this advantageously improves uniformity of the illumination intensity of the negative-pressure element.

In some embodiments, the negative-pressure element is designed such that a uniformity of the illumination intensity of at least 90% is achieved on an outwardly directed surface of the diffuser layer. In some embodiments, a uniformity of the illumination of at least 90% can refer to a uniformity of the illumination measured according to at least one of the following standards, in particular according to a standard of the ISO (International Organization of Standardization), VESA (Video Electronics Standard Association), SPWG (Standards Panel Working Group) or the like.

In some embodiments, the translucent layer, in particular the perforation of the translucent layer, is designed, in particular arranged, in such a way that a uniformity of the illumination intensity of at least 90% is achieved on a surface of the diffuser layer which is arranged opposite the layer adjacent to the translucent layer or which is arranged opposite the surface which adjoins the translucent layer.

Advantageously, in some embodiments, an application of the negative-pressure element can thereby be improved, in particular an edge detection of an object using a negative-pressure element described herein.

In some embodiments, the negative-pressure element has at least one electrical connection which is configured to make electrical contact with the at least one light source. In some embodiments, the electrical connection has a contact element which is set up for the electrical contacting of a complementary contact element of a negative-pressure work surface or of a work surface.

Advantageously, in some embodiments, the electrical connection can be arranged in such a way that the negative-pressure element can be connected electrically in a simple(r) manner, in particular by means of the contact element. In some embodiments, the negative-pressure element, in particular the electrical connection, can comprise at least one permanent magnet, in particular in order to be able to place the negative-pressure element, in particular the electrical connection of the negative-pressure element, (more) easily in, at or on a receptacle provided for the negative-pressure element, in particular a receptacle of a work surface or a negative-pressure work surface.

In some embodiments, the electrical connection with the at least one permanent magnet can be set up to place the electrical connection in, at or on a receptacle in such a way that the electrical connection is (electrically) contacted, in particular in such a way that the at least one light source is or can be supplied with current.

In some embodiments of the invention, a negative-pressure work surface is provided which has at least one negative-pressure element as described herein. In some embodiments, the work surface of the negative-pressure work surface and the surface (directed away from the negative-pressure element) of the diffuser layer of the negative-pressure element form a common, in particular planar, surface. Alternatively, in some embodiments, the at least one negative-pressure element is arranged with its diffuser layer on the negative-pressure work surface and the perforation of the diffuser layer corresponds to a perforation of the negative-pressure work surface, in particular in such a way that, when a negative-pressure is applied to the negative-pressure work surface and/or the negative-pressure element, air flows or can flow through the perforation of the negative-pressure work surface and through the perforation of the diffuser layer in the direction of the negative-pressure, in particular the negative-pressure device.

In some embodiments, the negative-pressure work surface is part of a negative-pressure work surface assembly or, in some embodiments, a negative-pressure work surface assembly has at least one negative-pressure work surface. The term “negative-pressure work surface assembly”, as used herein, is to be understood in particular in such a way that the negative-pressure work surface assembly is set up to form a negative-pressure on the negative-pressure work surface, in particular forms with the latter at least one space which can form a negative-pressure. In some embodiments, the negative-pressure work surface is installed loosely or removably in the negative-pressure work surface assembly, in particular has a seal, so that the negative-pressure work surface assembly with the negative-pressure work surface installed can form a negative-pressure which acts or can act on an object, in particular via the perforation of the negative-pressure work surface.

In some embodiments, the negative-pressure work surface assembly is designed in such a way that the distance between a bottom of the negative-pressure work surface assembly and the negative-pressure work surface corresponds, at least substantially, to the height of a negative-pressure element, so that the negative-pressure element can be accommodated or is accommodated in the space between the negative-pressure work surface and the bottom of the negative-pressure work surface assembly. In some embodiments, the bottom of the negative-pressure work surface assembly has at least one contact element which is complementary to a contact element of the electrical connection of the negative-pressure element. Advantageously, in some embodiments, this makes it possible for the negative-pressure element to be electrically contacted in a simple manner in the negative-pressure work surface assembly. In some embodiments, a negative-pressure work surface assembly can be integrated into a negative-pressure table. Alternatively, in some embodiments, the negative-pressure work surface assembly can be used in a roll-to-roll application or production.

As a result, in some embodiments, an object or a workpiece, in particular semi-finished product, can advantageously be pulled over the work surface and/or placed thereon. In some embodiments, the negative-pressure work surface can be used for edge detection of the objects or workpieces placed on the negative-pressure work surface, in particular semi-finished products, and can in particular make it possible for detection of the edge to be improved by the illumination of the edges of the object or of the workpiece by the at least one negative-pressure element, in particular by the increased contrast provided by the negative-pressure element.

In some embodiments, the negative-pressure work surface and/or the negative-pressure element has at least one seal which is configured to seal the work surface around the negative-pressure element, in particular in such a way that, by integrating the at least one negative-pressure element, a negative-pressure or a (technical) negative-pressure which is applied to the negative-pressure work surface can be kept at least substantially constant or remains constant.

In some embodiments, the negative-pressure work surface can have an area of at least 250 mm by at least 100 mm, in particular at least 350 mm by at least 100 mm. In some embodiments, the at least one negative-pressure element, which is integrated in particular into the negative-pressure work surface or is attached thereto, can have an area of at least 40 mm by 40 mm. In some embodiments, the negative-pressure work surface can have at least 5 times the area compared to the at least one negative-pressure element.

In some embodiments of the invention, a negative-pressure table is provided which has at least one negative-pressure work surface or a negative-pressure work surface assembly. In some embodiments, the at least one negative-pressure work surface of the negative-pressure table can correspond to the entire (working) surface of the negative-pressure table, in particular at least 90% of the surface, at least 75% of the surface, at least 50% of the surface and/or at most 50% of the surface. In some embodiments, the negative-pressure table can have two or more negative-pressure work surfaces or negative-pressure work surface assemblies.

In some embodiments of the invention, a method is provided for detecting the position of an object on a negative-pressure work surface or a work surface described herein. In some embodiments, the method comprises placing the object on a negative-pressure work surface or on a work surface, in particular a negative-pressure work surface described herein or a work surface described herein, wherein the negative-pressure work surface or the work surface has at least one negative-pressure element described herein, in particular in such a way that at least one edge of the object is located on a negative-pressure element of the negative-pressure work surface or on a negative-pressure element of the work surface. In some embodiments, the method comprises determining at least one edge position of the placed object on the at least one negative-pressure element. In some embodiments, the method further comprises determining a position of the object on the negative-pressure work surface or determining a position of the object on the work surface, in particular determining a position of the object on the negative-pressure work surface or the work surface. In some embodiments, the determination of the position of the object, in particular the determination of the position of the object, on the negative-pressure work surface or the work surface is based on the at least one determined edge position of the object and known dimensions of the object.

Advantageously, in some embodiments, a position and/or a position of the object on the negative-pressure work surface or on the work surface can be (more) precisely determined, in particular by means of a contrast at the edge of the object improved by the negative-pressure element. In some embodiments, a position of the object located on the negative-pressure work surface or on the work surface can be determined to 100 μm or better. In some embodiments, further processing of the object can be carried out more precisely, in particular more precisely in terms of position.

As possibly used herein, the terms “comprises,” “contains,” “includes,” “encompasses,” “has,” “with,” or any other variant thereof are intended to cover non-exclusive inclusion. For example, a method or a device that comprises or has a list of elements is not necessarily restricted to these elements, but may include other elements that are not expressly listed or that are inherent to such a method or such a device.

Furthermore, unless expressly stated to the contrary, “or” refers to an inclusive or and not to an exclusive “or”. For example, a condition A or B is met by one of the following conditions: A is true (or present) and B is false (or absent), A is false (or absent) and B is true (or present), and both A and B are true (or present).

The terms “a” or “an” as used herein, are defined in the meaning of “one or more”. The terms “another” and “a further” and any other variant thereof are to be understood to mean “at least one other”.

The term “configured” or “designed” to perform a specific function (and respective modifications thereof), possibly used herein, is to be understood to mean that the corresponding device or a component thereof is already provided in a design or setting in which it can execute the function or that it is at least adjustable—namely configurable—so that it can execute the function after corresponding adjustment. The configuration can take place, for example, via a corresponding setting of parameters of a process course or of switches or the like for activating or deactivating functionalities or settings. In particular, the device can have multiple predetermined configurations or operating modes, so that the configuration can be carried out by selecting one of these configurations or operating modes.

Preferred exemplary embodiments of the method described herein, in particular their respective features can in each case, unless expressly excluded or technically impossible, be combined as desired with one another and with features of the described method, in particular to form new embodiments. In particular, embodiments of the negative-pressure work surface described herein (by way of example), in particular the features thereof, in each case where this is not technically impossible or excluded, can be transferred to the work surface which is not set up for negative-pressure or can be combined with one another (as desired), in particular to form new embodiments of the work surface. This applies analogously to embodiments of a corresponding work surface assembly or a negative-pressure table which have at least one work surface.

The method described herein is preferably designed for execution by means of the negative-pressure work surface according to the invention or the work surface according to the invention, in particular an embodiment thereof described herein. The negative-pressure work surface or the work surface is preferably designed for carrying out the process described herein, in particular an embodiment thereof described herein.

Further advantages, features, and possible applications of the present invention result from the following description in more detail in conjunction with the figures.

In particular

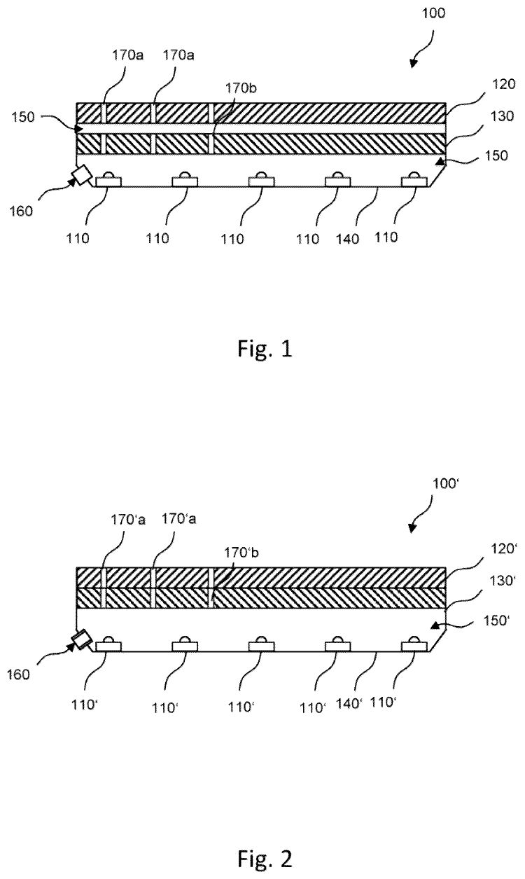

FIG. 1 is a schematic sectional side view of a negative-pressure element according to an embodiment;

FIG. 2 is a schematic sectional side view of a negative-pressure element according to an alternative embodiment;

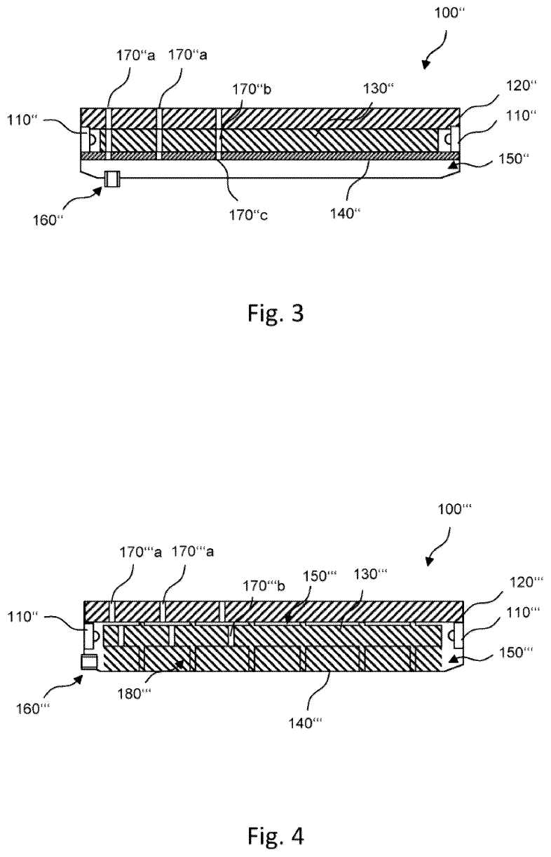

FIG. 3 is a schematic sectional side view of a negative-pressure element according to a further alternative embodiment;

FIG. 4 is a schematic sectional side view of a negative-pressure element according to a further alternative embodiment;

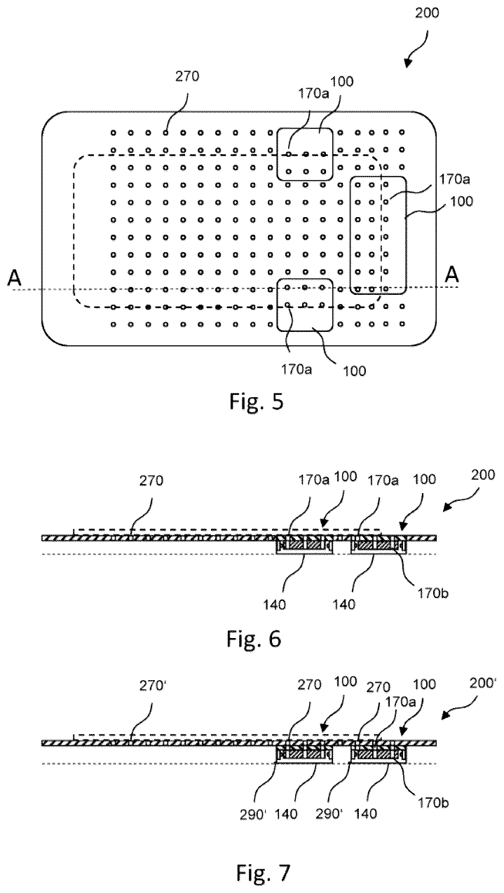

FIG. 5 schematically shows a negative-pressure work surface with three negative-pressure elements according to an embodiment;

FIG. 6 schematically shows a section through a negative-pressure work surface in an embodiment; and

FIG. 7 schematically shows a section through a negative-pressure work surface in an alternative embodiment.

In the figures, the same reference numerals denote the same, similar or corresponding elements. Elements depicted in the figures are not necessarily represented to scale. Rather, the various elements shown in the figures are presented in such a way that their function and general purpose can be understood by those skilled in the art. Connections and couplings, shown in the figures, between functional units and elements can also be implemented as an indirect connection or coupling, unless expressly stated otherwise. Functional units can be implemented in particular as hardware, software or a combination of hardware and software.

FIG. 1 schematically shows an embodiment of a negative-pressure element 100 in a sectional view through the negative-pressure element 100. The negative-pressure element 100 has, from bottom to top, a reflection surface 140, a first volume 150, a translucent layer 130, a second volume 150 and a diffuser layer 120, wherein the top corresponds to a surface of the diffuser layer 120 on which, for example, an object or a workpiece can be placed or which can be attached to a negative-pressure work surface, as described later on in connection with FIG. 7. The reflection layer 140 reflects light from the light sources 110 in the direction of the translucent layer 130. In some embodiments, a reflection layer 140 can also be arranged (i.e. additionally or alternatively) on the sides of the negative-pressure element 100, so that in particular light from the light source or sources 110 is (retro)reflected into the negative-pressure element 100, and is further reflected in particular in such a way that the light reaches the diffuser layer 120, for example via the translucent layer 130. FIG. 1 also shows a connection 160, which here is designed as an example as an opening of the negative-pressure element and connects the negative-pressure element 100 to a negative-pressure which exists or can exist outside the negative-pressure element. This negative pressure is passed on via the perforation 170b of the translucent layer 130 and the perforation 170a of the diffuser layer 120 to the surface of the diffuser layer 120, so that, for example, an object lying on this surface can be or is fixed to the surface by the negative pressure. Air can flow correspondingly from a normal pressure or a pressure which is higher than the negative pressure at the connection 160 through the perforations 170a, 170b and the volumes 150 in the direction of the connection 160 and thereby in particular generate a negative pressure “holding force” on the surface of the diffuser layer 120. The volumes 150 are shown in the figure in such a way that they extend over the entire width of the negative-pressure element. In some embodiments, the volume 150 or the volumes 150 can extend only over a part of the negative-pressure element, in particular over the part which has a perforation 170a, 170b.

FIG. 2 shows a (different) embodiment of the negative-pressure element 100′, which has the same or similar features to FIG. 1, as can be seen from the reference numerals. FIG. 2 differs from the embodiment shown in FIG. 1 in that only one volume 150′ is shown schematically. Correspondingly, the diffuser layer 120′ and the translucent layer 130′ are arranged in contact with one another. The perforation 170′a, 170′b is designed in such a way that an air flow in the direction of a negative-pressure can be or is ensured. Furthermore, FIG. 2 shows a connection 160′ which permits or can permit the connection of a (technical) vacuum or negative pressure, in particular via a standardized interface or via a standardized connection. The light sources 110′, as also in FIG. 1, are arranged in such a way that an at least substantially uniform illumination intensity prevails over at least a part or the entire surface of the diffuser layer 120′ on the surface of the diffuser layer 120′ which is at the top in the sheet direction.

FIG. 3 shows an embodiment of the negative-pressure element 100″ with laterally arranged light sources 110″ which emit light in the direction of the translucent layer 130″. The translucent layer 130″ is arranged between a reflection layer 140″ and a diffuser layer 120″. In some embodiments, further reflection layers and/or reflection surfaces can be arranged in the negative-pressure element, which in particular reflect light from the at least one light source or the light sources 110″ in the direction of the diffuser layer 120″. The embodiment shown in FIG. 3 also has a perforation 170″c in the reflection layer 140″. The volume 150″ is arranged in a sequence of layers below the reflective layer 140″ and creates a fluid connection from the connection 160″ to the perforation 170″a, so that a fluid, in particular air, can flow through the perforation 170″a, 170′b, 170′c in the direction of a negative-pressure or vacuum, in particular in the direction of a negative-pressure device.

FIG. 4 schematically shows an embodiment of the negative-pressure element 100′″ in which the translucent layer 130′″ has supporting structures 180′″. The supporting structures 180′″ support the space spanned by the volumes 150′″, so that the negative-pressure element 100′″ is in particular (more) stable. Furthermore, it is schematically shown that the perforations 170′″b, 170′″a of the translucent layer 130′″ and of the diffuser layer 120′″ are arranged offset from one another in such a way that air can flow or flows through the perforation 170′″a, 170′″b, in particular through the perforation 170′″a, 170′″b and the volumes 150′″ in the direction of negative pressure, that is to say leaves the negative pressure element 100′″ at the (at least one) connection 160′″.

FIG. 5 schematically shows a negative-pressure work surface 200 in a plan view. In the embodiment shown, the negative-pressure work surface 200 has three negative-pressure elements 100 which are arranged in such a way that the edge or edges of the object deposited on the negative-pressure work surface 200 (shown in dashed lines) can be illuminated on predetermined sides of the object by the negative-pressure elements 100 or are illuminated when the object is placed on the negative-pressure work surface 200. The negative-pressure elements 100 show, in sections, the perforation 170a of the diffuser layer 120 in plan view, through which the object can be held down or is held down. Furthermore, the negative-pressure work surface 200 itself has a perforation 270 which can also hold down or holds down the object, in particular fixed on the negative-pressure work surface 200. Furthermore, FIG. 5 shows a section line A-A which indicates the section plane for FIGS. 6 and 7 by dashed lines. The negative-pressure elements 100 are shown in different sizes and in some embodiments can be adapted to the edge shape of the object or have any other shape which has the features described herein. Likewise, in some embodiments, the negative-pressure work surface may form a shape and/or surface other than that shown here, in particular depending on the object or workpiece.

FIG. 6 schematically shows an embodiment of a negative-pressure work surface 200 in a side view of a section which leads along the line A-A indicated in FIG. 5. Correspondingly, FIG. 6 shows two negative-pressure elements 100 in section, which are integrated into the work surface of the negative-pressure work surface. For this purpose, the negative-pressure element 100 or the recess in the negative-pressure work surface 200, which is designed to receive the negative-pressure element 100, may have a seal in some embodiments. FIG. 6 also shows an exemplary object lying on the negative-pressure work surface in dashed lines, which object becomes or is fixed on the surface by the negative-pressure applied to the perforation 170a-b, 270. A further dashed line indicates a lower bottom of the negative-pressure work surface. This serves to illustrate a possible (low) structural height of the negative-pressure work surface.

FIG. 7 shows an alternative embodiment of a negative-pressure work surface 200′ in a side view as a sectional representation according to the sectional line A-A indicated in FIG. 5. In contrast to FIG. 6, the negative-pressure element 100 in FIG. 7 is not integrated into the negative-pressure work surface, in particular into a recess in the negative-pressure work surface 200′, but is mounted on the negative-pressure work surface 200′. The diffuser layer of the negative-pressure element 100 is in contact with the negative-pressure work surface 200′, so that the light scattered by the diffuser layer shines through the work surface of the negative-pressure work surface 200′. The negative-pressure work surface 200′ consists (in some embodiments) of a corresponding material which is suitable for this purpose. FIG. 7 also shows electrical connections 290′ which, when the negative-pressure work surface 200′ and/or a negative-pressure work surface assembly has corresponding complementary connections, are designed to electrically connect the at least one light source 110 of the negative-pressure element 100. For this purpose, the negative-pressure work surface 200′ may have corresponding connections in some embodiments, in particular in a bottom (which is indicated by a dashed line in FIG. 7) terminating the negative-pressure work surface assembly. The perforation of the diffuser layer 120 and the perforation of the work surface 200 coincide in such a way that a negative pressure can act or acts on the work surface, in particular when it bears against one of the negative pressure elements 100 and/or the negative pressure work surface 200.

While at least one exemplary embodiment has been described above, it is to be noted that a large number of variations thereto exist. It is also to be noted that the exemplary embodiments described only represent non-limiting examples, and are not intended to restrict the scope, the applicability, or the configuration of the devices and methods described herein. Rather, the preceding description will provide those skilled in the art with guidance for implementing at least one exemplary embodiment, wherein it is apparent that various changes in the operation and arrangement of elements described in an exemplary embodiment may be made without departing from the scope of the subject matter defined in the appended claims and their legal equivalents.

### LIST OF REFERENCE NUMERALS

100, 100′, 100″, 100′″ negative-pressure element
110, 110′, 110″, 110′″ light source
120, 120′, 120″, 120′″ diffuser layer
130, 130′, 130″, 130′″ translucent layer
140, 140′, 140″, 140′″ reflective surface or layer
150, 150′, 150″, 150′″ volume
160, 160′, 160″, 160″′ connection
170a-b, 170′a-b, 170″a-c, 170′″a-c perforation
180′″ support structures
200, 200′ negative-pressure work surface
270′ work surface perforation
290′ electrical connection

What is claimed is:

1. A negative-pressure element for arrangement in and/or on a work surface or in and/or on a negative-pressure work surface, wherein said negative-pressure element comprises:
at least one connection designed to connect a negative pressure and/or a negative-pressure device;
a diffuser layer, wherein the diffuser layer has a perforation at least in sections, wherein the perforation of the diffuser layer is designed in such a way that, when a negative-pressure is applied to the negative-pressure element air can flow through the respective perforation towards the negative-pressure device;
a translucent layer in particular a light-guiding layer, wherein the translucent layer is designed to couple light into the diffuser layer;
at least one light source, in particular at least one LED, which is configured to emit light towards the translucent layer;
at least one volume which is designed to distribute a negative pressure applied to the at least one connection to the perforation, in particular to at least one part of the perforation and wherein the negative-pressure element is designed in such a way that it can be arranged on a work surface, which has a perforation complementary to the negative-pressure element, or on a perforated negative-pressure work surface, or that the negative-pressure element can be integrated into a recess of a work surface or a negative-pressure work surface

2. The negative-pressure element according to the preceding claim 1, wherein the light source is arranged in such a way that the light source radiates laterally into the translucent layer, wherein the light source is arranged in particular on a side of the negative-pressure element which is arranged, in particular at least substantially, perpendicularly to the surface of the diffuser layer.

3. The negative-pressure element according to claim 1, wherein the negative-pressure element has at least one reflection surface which is designed to reflect the light emitted by the at least one light source and/or the light emerging from the translucent layer in the direction of the translucent layer and/or of the diffuser layer.

4. The negative-pressure element according to claim 1, wherein the at least one volume is arranged in sections between the at least one reflective surface and the translucent layer and wherein the translucent layer has at least in sections a perforation which is formed such that when a negative-pressure is applied to the negative-pressure element air can flow towards the negative-pressure device, or in that the at least one volume is adjacent to the reflective surface, wherein the reflective surface has a perforation which is formed such that when a negative-pressure is applied to the negative-pressure element, air can flow in the direction of the negative-pressure device.

5. The negative-pressure element according claim 1, characterized in that the diffuser layer, the translucent layer and/or the reflection surface has supporting structures, in particular supporting structures, which are designed to support the at least one volume.

6. The negative-pressure element according to claim 1, characterized in that the perforation of the diffuser layer is arranged offset from the perforation of the translucent layer.

7. The negative-pressure element according to claim 4, wherein the at least one volume is adjacent to the reflective surface, wherein the reflective surface has a perforation which is formed such that when a negative-pressure is applied to the negative-pressure element, air can flow in the direction of the negative-pressure device, and wherein the perforation of the reflection surface is arranged offset from the perforation of the translucent layer.

8. The negative-pressure element according to claim 1, wherein a uniformity of the illuminance of at least 90% is achieved on an outwardly directed surface of the diffuser layer, which forms an outer surface of the negative-pressure element, and/or in that the translucent layer, in particular the perforation of the translucent layer, is designed, in particular arranged, in such a way that a uniformity of the illuminance of at least 90% is achieved on a surface of the diffuser layer, which is arranged opposite the surface of the diffuser layer adjacent to the translucent layer or which is opposite the surface adjacent to the translucent layer.

9. The negative-pressure element according to claim 1, wherein the negative-pressure element further comprises at least one electrical connection configured to electrically contact the at least one light source, and wherein the electrical connection comprises a contact element adapted to electrically contact a complementary contact element of a negative-pressure work surface.

10. The negative-pressure work surface or work surface comprising at least one negative-pressure element according to claim 1, wherein in particular the negative-pressure work surface or the work surface and the surface of the diffuser layer of the negative-pressure element form a common, in particular planar, surface or wherein the at least one negative-pressure element is arranged with its diffuser layer on the negative-pressure work surface or the work surface and the perforation of the diffuser layer corresponds to a perforation of the negative-pressure work surface or a perforation of the work surface.

11. A method for detecting the position of an object on a negative-pressure work surface or on a work surface, the method comprising:
placing the object on a negative-pressure work surface or on a work surface according to claim 10;
determining at least one edge position of the placed object on the at least one illuminated negative-pressure element of the negative-pressure work surface or the work surface; and
determining a position of the object on the negative-pressure work surface or the work surface, in particular a position of the object, based on the at least one determined edge position and known dimensions of the object.

12. The negative-pressure element according to claim 3, wherein the negative-pressure element has at least one reflection surface which is designed to reflect the light emitted by the at least one light source and/or the light emerging from the translucent layer in the direction of the translucent layer and/or of the diffuser layer.

13. The negative-pressure element according to claim 2, wherein the at least one volume is arranged in sections between the at least one reflective surface and the translucent layer and wherein the translucent layer has at least in sections a perforation which is formed such that when a negative-pressure is applied to the negative-pressure element air can flow towards the negative-pressure device, or in that the at least one volume is adjacent to the reflective surface, wherein the reflective surface has a perforation which is formed such that when a negative-pressure is applied to the negative-pressure element, air can flow in the direction of the negative-pressure device.

14. The negative-pressure element according claim 2, characterized in that the diffuser layer, the translucent layer and/or the reflection surface has supporting structures, in particular supporting structures, which are designed to support the at least one volume.

15. The negative-pressure element according to claim 2, characterized in that the perforation of the diffuser layer is arranged offset from the perforation of the translucent layer.

16. The negative-pressure element according to claim 5,, and wherein the perforation of the reflection surface is arranged offset from the perforation of the translucent layer.

17. The negative-pressure element according to claim 6,, and wherein the perforation of the reflection surface is arranged offset from the perforation of the translucent layer.

18. The negative-pressure element according to claim 2, wherein a uniformity of the illuminance of at least 90% is achieved on an outwardly directed surface of the diffuser layer, which forms an outer surface of the negative-pressure element, and/or in that the translucent layer, in particular the perforation of the translucent layer, is designed, in particular arranged, in such a way that a uniformity of the illuminance of at least 90% is achieved on a surface of the diffuser layer, which is arranged opposite the surface of the diffuser layer adjacent to the translucent layer or which is opposite the surface adjacent to the translucent layer.

19. The negative-pressure element according to claim 2, wherein the negative-pressure element further comprises at least one electrical connection configured to electrically contact the at least one light source, and wherein the electrical connection comprises a contact element adapted to electrically contact a complementary contact element of a negative-pressure work surface.

20. The negative-pressure element according to claim 3, wherein the negative-pressure element further comprises at least one electrical connection configured to electrically contact the at least one light source, and wherein the electrical connection comprises a contact element adapted to electrically contact a complementary contact element of a negative-pressure work surface.
